(19) United States
(12) Patent Application Publication
(10) Pub. No.: US 2024/0062208 A1
(43) Pub. Date: Feb. 22, 2024

(54) FACIAL RECOGNITION PAYMENT METHODS AND APPARATUSES

(71) Applicant: Alipay (Hangzhou) Information Technology Co., Ltd., Hangzhou (CN)

(72) Inventors: Xiaoguang HE, Hangzhou (CN); Xu LI, Hangzhou (CN)

(21) Appl. No.: 18/270,459

(22) PCT Filed: Jan. 6, 2022
(86) PCT No.: PCT/CN2022/070469

§ 371 Date: Jun. 29, 2023

(30) Foreign Application Priority Data
Jan. 11, 2021 (CN) 202110028627.8

(51) Int. Cl. G06Q 20/40

(52) U.S. Cl. CPC G06Q 20/40145; G06Q 20/4016

(57) ABSTRACT

Embodiments of this specification provide a facial recognition payment method and apparatus. In the method, it is first determined whether a facial recognition payment trigger event is detected; if yes, a face image is obtained; identity verification is performed on a user based on the obtained face image; after the identity verification on the user succeeds, risk data of the user are obtained; it is determined, by using the risk data of the user, whether a payment risk of a transaction is controllable; and if yes, the user is notified that the user can leave.

### TECHNICAL FIELD

One or more embodiments of this specification relate to electronic information technologies, and in particular, to facial recognition payment methods and apparatuses.

### BACKGROUND

Facial recognition payment is a new payment manner with facial recognition as a core. A facial recognition payment process is very simple. A user does not need to carry a wallet, a bank card, or a mobile phone. During payment, the user only needs to face a screen of a point of sales (POS) terminal. A facial recognition payment system automatically associates facial information of the user with a personal account of the user, and completes transaction deduction for the user. The entire transaction process is very convenient.

However, in a current facial recognition payment process, the user needs to wait until transaction deduction of facial recognition payment succeeds. In this case, the user can leave. This increases waiting time of the user. Therefore, an improved solution is expected, so that the waiting time of the user in the facial recognition payment process can be reduced.

### SUMMARY

One or more embodiments of this specification describe facial recognition payment methods and apparatuses, so that waiting time of a user can be reduced.

According to a first aspect, a facial recognition payment method is provided, including the following: detecting a facial recognition payment trigger event; obtaining a face image; performing identity verification on a user based on the obtained face image; after the identity verification on the user succeeds, obtaining risk data of the user; determining, by using the risk data of the user, whether a payment risk of a transaction is controllable; and if yes, notifying the user that the user can leave.

In an embodiment of this specification, the detecting a facial recognition payment trigger event includes any one of the following: detecting that a face appears on a screen of a facial recognition device; detecting a tap input on a facial recognition payment button, where the facial recognition payment button is located on the screen of the facial recognition device; detecting a key operation that is entered by using a physical keyboard and that corresponds to facial recognition payment; detecting that an eye of a face gazes at the screen of the facial recognition device; detecting that a human body movement corresponding to facial recognition payment appears on the screen of the facial recognition device; and detecting a voice password corresponding to facial recognition payment.

In an embodiment of this specification, after the obtaining a face image, and before the performing identity verification on a user based on the obtained face image, any one of the following processing further is performed: performing attention recognition based on the obtained face image, and if it is determined that attention is on the screen of the facial recognition device, continuing to perform the step of performing identity verification on a user based on the obtained face image; determining whether at least two face images are currently obtained, if yes, calculating spatial location data of a face corresponding to each face image relative to the screen of the facial recognition device, calculating a probability corresponding to each face image by using the calculated spatial location data, determining a face image with a maximum probability value as a face image of the user, and performing identity verification on the user based on the face image of the user; and detecting whether a human torso appears on the screen of the facial recognition device, if yes, determining whether the human torso and the obtained face image belong to a same user, and if yes, continuing to perform the step of performing identity verification on a user based on the obtained face image.

In an embodiment of this specification, the performing identity verification on a user based on the obtained face image includes the following: performing liveness detection based on the obtained face image; and if the liveness detection succeeds, performing facial recognition based on the obtained face image, determining whether a user identity corresponding to the face image can be recognized, and if yes, enabling the identity verification on the user succeeds.

In an embodiment of this specification, the obtaining risk data of the user includes the following: obtaining user risk data in N dimensions, where N is a positive integer; and performing normalization processing on user risk data in each dimension, to obtain a user risk vector in the dimension; and the determining, by using the risk data, whether a payment risk of a transaction is controllable includes the following: calculating a user risk value by using the following equation:

$${R}^{u} ( {X}^{u} ) = {( {\prod }_{n = 1}^{N} {x}_{n}^{u} )}^{\frac{1}{a N}} , where 0 \leq {x}_{n}^{u} \leq 1 , constant a > 1$$

Here R^{u} (X^{u}) represents the user risk value, xₙ^{u} represents a user risk vector in an n^{th} dimension, and n is any integer from 1 to N; determining whether the user risk value is greater than a first predetermined value; and if yes, determining that the payment risk of the transaction is controllable.

In an embodiment of this specification, before the notifying the user that the user can leave, the method further includes the following: obtaining risk data of a facial recognition device; determining, by using the risk data of the facial recognition device, whether the payment risk of the transaction is controllable; and if yes, continuing to perform the step of notifying the user that the user can leave.

In an embodiment of this specification, the obtaining risk data of a facial recognition device includes the following: obtaining risk data of the facial recognition device in M dimensions, where M is a positive integer; and performing normalization processing on risk data of the facial recognition device in each dimension, to obtain a risk vector of the facial recognition device in the dimension; and the determining, by using the risk data of the facial recognition device, whether the payment risk of the transaction is controllable includes the following: calculating a device risk value by using the following equation:

$${R}^{d} ( {X}^{d} ) = {\prod }_{m = 1}^{M} {x}_{m}^{d} ,$$

Here R^{d}(X^{d}) represents the device risk value, xₘ^{d} represents a device risk vector in an m^{th} dimension, a value of xₘ^{d} is 0 or 1, and m is any integer from 1 to M; determining whether the device risk value is 1; and if yes, determining that the payment risk of the transaction is controllable.

In an embodiment of this specification, the risk data of the facial recognition device include any one of the following: risk data of a software environment of the facial recognition device, risk data of a hardware environment of the facial recognition device, and communication network risk data.

In an embodiment of this specification, before the notifying the user that the user can leave, the method further includes the following: obtaining risk data of a merchant; determining, by using the risk data of the merchant, whether the payment risk of the transaction is controllable; and if yes, continuing to perform the step of notifying the user that the user can leave.

In an embodiment of this specification, the obtaining risk data of a merchant includes the following: obtaining merchant risk data in I dimensions, where I is a positive integer; and performing normalization processing on merchant risk data in each dimension, to obtain a merchant risk vector in the dimension; and the determining, by using the risk data of the merchant, whether the payment risk of the transaction is controllable includes the following: calculating a merchant risk value by using the following equation:

$${R}^{m} ( {X}^{m} ) = {( {\prod }_{i = 1}^{I} {x}_{i}^{m} )}^{\frac{b}{I}} , where 0 \leq {x}_{i}^{m} \leq 1 , constant b > 1$$

Here R^{m}(Xₘ) represents the merchant risk value, xᵢ^{m} represents a merchant risk vector in an i^{th} dimension, and i is any integer from 1 to I; determining whether the merchant risk value is greater than a second predetermined value; and if yes, determining that the payment risk of the transaction is controllable.

In an embodiment of this specification, the risk data of the merchant include any one of the following: historical behavior data of the merchant, credit status data of the user, and service level data of the merchant.

In an embodiment of this specification, the risk data of the user include any one of the following: historical behavior data of the user, consumption capability statistics data of the user, credit status data of the user, and a Zhima credit score of the user.

In an embodiment of this specification, after it is determined, by using the risk data, that the payment risk of the transaction is controllable, the method further includes the following: performing deduction processing by using account information of the user, and if the deduction does not succeed, performing deduction from an account of a pre-established facial recognition payment fund pool; and/or after it is determined, by using the risk data, that the payment risk of the transaction is not controllable, the method further includes the following: performing deduction processing by using account information of the user; and if the deduction does not succeed, notifying the user that the deduction fails; or if the deduction succeeds, notifying the user that the user can leave.

According to a second aspect, a facial recognition payment apparatus is provided, including the following: a facial recognition payment start module, configured to obtain a face image after a facial recognition payment trigger event is detected; an identity verification module, configured to perform identity verification on a user based on the obtained face image; a risk control module, configured to: after the identity verification on the user succeeds, obtain risk data of the user, and determine, by using the risk data of the user, whether a payment risk of a transaction is controllable; and a notification module, configured to: after the risk control module determines that the payment risk of the transaction is controllable, notify the user that the user can leave.

In an embodiment of this specification, the facial recognition payment start module is configured to: when any one of the following is detected, determine that the facial recognition payment trigger event is detected: detecting that a face appears on a screen of a facial recognition device; detecting a tap input on a facial recognition payment button, where the facial recognition payment button is located on the screen of the facial recognition device; detecting a key operation that is entered by using a physical keyboard and that corresponds to facial recognition payment; detecting that an eye of a face gazes at the screen of the facial recognition device; detecting that a human body movement corresponding to facial recognition payment appears on the screen of the facial recognition device; and detecting a voice password corresponding to facial recognition payment.

In an embodiment of this specification, the apparatus further includes: a payment confirmation module, where the payment confirmation module is configured to perform any one of the following processing: performing attention recognition based on the obtained face image, and if it is determined that attention is on the screen of the facial recognition device, triggering the identity verification module to perform the step of performing identity verification on a user based on the obtained face image; determining whether at least two face images are currently obtained, if yes, calculating spatial location data of a face corresponding to each face image relative to the screen of the facial recognition device, calculating a probability corresponding to each face object by using the calculated spatial location data, determining a face image with a maximum probability value as a face image of the user, and triggering the identity verification module to perform the step of performing identity verification on a user based on the obtained face image; and detecting whether a human torso appears on the screen of the facial recognition device, if yes, determining whether the human torso and the obtained face image belong to a same user, and if yes, triggering the identity verification module to perform the step of performing identity verification on a user based on the obtained face image.

In an embodiment of this specification, the risk control module is configured to perform the following processing: obtaining user risk data in N dimensions, where N is a positive integer; and performing normalization processing on user risk data in each dimension, to obtain a user risk vector in the dimension; and the determining, by using the risk data, whether a payment risk of a transaction is controllable includes the following: calculating a user risk value by using the following equation:

$${R}^{u} ( {X}^{u} ) = {( {\prod }_{n = 1}^{N} {x}_{n}^{u} )}^{\frac{1}{a N}} , where 0 \leq {x}_{n}^{u} \leq 1 , constant a > 1$$

Here R^{u}(X^{u}) represents the user risk value, xₙ^{u} represents a user risk vector in an n^{th} dimension, and n is any integer from 1 to N; determining whether the user risk value is greater than a first predetermined value; and if yes, determining that the payment risk of the transaction is controllable.

In an embodiment of this specification, the risk control module is further configured to perform the following processing: obtaining risk data of a facial recognition device; and determining, by using the risk data of the facial recognition device, whether the payment risk of the transaction is controllable.

In an embodiment of this specification, the risk control module is configured to perform the following processing: obtaining risk data of the facial recognition device in M dimensions, where M is a positive integer; and performing normalization processing on risk data of the facial recognition device in each dimension, to obtain a risk vector of the facial recognition device in the dimension; and the determining, by using the risk data of the facial recognition device, whether the payment risk of the transaction is controllable includes the following: calculating a device risk value by using the following equation:

$${R}^{d} ( {X}^{d} ) = {\prod }_{m = 1}^{M} {x}_{m}^{d} ,$$

Here R^{d}(X^{d}) represents the device risk value, xₘ^{d} represents a device risk vector in an m^{th} dimension, a value of xₘ^{d} is 0 or 1, and m is any integer from 1 to M; determining whether the device risk value is 1; and if yes, determining that the payment risk of the transaction is controllable.

In an embodiment of this specification, the risk data of the facial recognition

device include any one of the following: risk data of a software environment of the facial recognition device, risk data of a hardware environment of the facial recognition device, and communication network risk data.

In an embodiment of this specification, the risk control module is further configured to perform the following processing: obtaining risk data of a merchant; determining, by using the risk data of the merchant, whether the payment risk of the transaction is controllable; and if yes, continuing to perform the step of notifying the user that the user can leave.

In an embodiment of this specification, the risk control module is configured to perform the following processing: the obtaining risk data of a merchant includes the following: obtaining merchant risk data in I dimensions, where I is a positive integer; and performing normalization processing on merchant risk data in each dimension, to obtain a merchant risk vector in the dimension; and the determining, by using the risk data of the merchant, whether the payment risk of the transaction is controllable includes the following: calculating a merchant risk value by using the following equation:

$${R}^{m} ( {X}^{m} ) = {( {\prod }_{i = 1}^{I} {x}_{i}^{m} )}^{\frac{b}{I}} , where 0 \leq {x}_{i}^{m} \leq 1 , constant b > 1$$

Here R^{m}(X^{m}) represents the merchant risk value, xᵢ^{m} represents a merchant risk vector in an i^{th} dimension, and i is any integer from 1 to I; determining whether the merchant risk value is greater than a second predetermined value; and if yes, determining that the payment risk of the transaction is controllable.

In an embodiment of this specification, the risk data of the merchant include any one of the following: historical behavior data of the merchant, credit status data of the user, and service level data of the merchant.

In an embodiment of this specification, the risk data of the user include any one of the following: historical behavior data of the user, consumption capability statistics data of the user, credit status data of the user, and a Zhima credit score of the user.

In an embodiment of this specification, the apparatus further includes a deduction processing module, where the deduction processing module is configured to perform at least one of the following processing: after the risk control module determines that the payment risk of the transaction is controllable, performing deduction processing by using obtained account information of the user, and if the deduction does not succeed, performing deduction from an account of a pre-established facial recognition payment fund pool; and/or after the risk control module determines that the payment risk of the transaction is not controllable, performing deduction processing by using obtained account information of the user; and if the deduction does not succeed, notifying the user that the deduction fails; or if the deduction succeeds, notifying the user that the user can leave.

According to a third aspect, a computer-readable storage medium that stores a computer program is provided, where when the computer program is executed on a computer, the computer is enabled to perform the method described in any one of the embodiments of this specification.

According to a fourth aspect, a computing device is provided, including a memory and a processor, where the memory stores executable code, and when executing the executable code, the processor implements the method described in any one of the embodiments of this specification.

Based on the facial recognition payment method and apparatus provided in the embodiments of this specification, once the identity verification on the user succeeds and it is determined that the payment risk of the transaction is controllable, the user can leave. In this way, the user does not need to wait on-site during processing of a subsequent acquiring and payment phase, thereby reducing waiting time of the user.

### BRIEF DESCRIPTION OF DRAWINGS

To describe the technical solutions in embodiments of this application or in the existing technology more clearly, the following briefly describes the accompanying drawings needed for describing the embodiments or the existing technology. Apparently, the accompanying drawings in the following description show some embodiments of this application, and a person of ordinary skill in the art can still derive other drawings from these accompanying drawings without creative efforts.

FIG. 1 is a flowchart illustrating a facial recognition payment method, according to an embodiment of this specification;

FIG. 2 is a schematic structural diagram illustrating a facial recognition payment apparatus, according to an embodiment of this specification;

FIG. 3 is another schematic structural diagram illustrating a facial recognition payment apparatus, according to an embodiment of this specification; and

FIG. 4 is still another schematic structural diagram illustrating a facial recognition payment apparatus, according to an embodiment of this specification.

### DESCRIPTION OF EMBODIMENTS

The following describes the solutions provided in this specification with reference to the accompanying drawings.

In an existing facial recognition payment process, after facial recognition is performed on a user, a face image can be obtained, and identity verification is performed on the user. After the verification succeeds, processing of an acquiring and payment phase needs to be performed. The processing of the acquiring and payment phase includes the following: The user confirms payment, a payment code corresponding to the user is obtained, and deduction processing is performed on a transaction of the user based on the payment code. After the acquiring and payment phase is completed and the deduction succeeds, the user is notified that the user can leave.

It can be seen that, in the existing facial recognition payment process, even if the identity verification on the user succeeds, the user cannot leave. Instead, the user needs to wait until the entire acquiring and payment phase is completed and the deduction succeeds. In this case, the user can leave. As a result, waiting time of the user is increased. Very long waiting time of the user leads to poor user experience, and limits service development.

It can be learned from analysis of the facial recognition payment process that,

when identity verification is performed on the user, processing on the user is involved. Therefore, the user needs to wait on-site, and cannot leave. However, once the identity verification on the user succeeds, because the user has completed facial recognition, processing of the subsequent acquiring and payment phase is not necessarily related to whether the user is on-site. The acquiring and payment phase is related to a payment capability of the user. In other words, after the identity verification on the user succeeds and a payment risk of the user is controllable, the user does not need to wait on-site, and can leave at any time, thereby reducing the waiting time of the user.

The following describes a specific implementation of the concept provided in this specification.

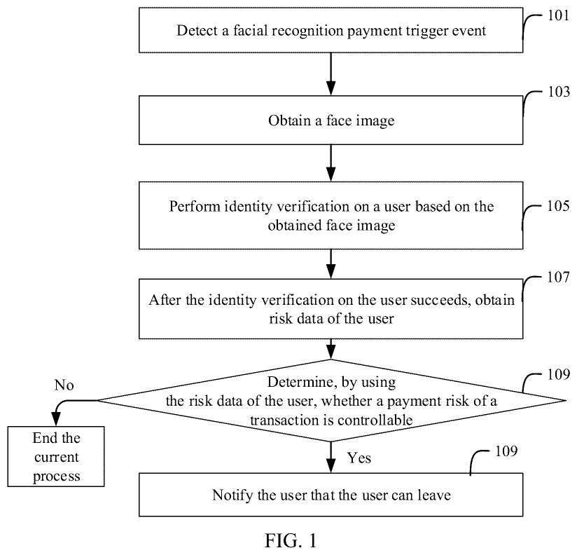

FIG. 1 is a flowchart illustrating a facial recognition payment method, according to an embodiment. It can be understood that the method can be performed by any apparatus, device, platform, or device cluster that has computing and processing capabilities. Referring to FIG. 1, the method includes the following steps: Step 101: Detect a facial recognition payment trigger event. Step 103: Obtain a face image. Step 105: Perform identity verification on a user based on the obtained face image. Step 107: After the identity verification on the user succeeds, obtain risk data of the user. Step 109: Determine, by using the risk data of the user, whether a payment risk of a transaction is controllable, and if yes, notify the user that the user can leave.

It can be learned that in the process shown in FIG. 1, once the identity verification on the user succeeds and it is determined that the payment risk of the transaction is controllable, the user can leave. In this way, the user does not need to wait on-site during processing of a subsequent acquiring and payment phase, thereby reducing waiting time of the user.

The following describes the steps shown in FIG. 1.

In an embodiment of this specification, the facial recognition payment trigger event detected in step 101 can include any one of the following trigger events: Trigger event 1: It is detected that a face appears on a screen of a facial recognition device.

In the trigger event 1, if a face appears on the screen of the facial recognition device, it can indicate that the user stands in front of the facial recognition device, indicating that the user has an intention of facial recognition payment. Therefore, the event can be used as the facial recognition payment trigger event to start a facial recognition payment process.

In addition, the trigger event 1 can indicate that the facial recognition payment process currently needs to be started, and can also indicate that the user has a payment intention. After the trigger event 1 is applied, in this embodiment of this specification, confirmation of the payment intention of the user can be advanced to a facial recognition payment start phase, instead of the existing technology where the user needs to confirm the payment intention in the acquiring and payment phase after the identity verification on the user succeeds. After the trigger event 1 is applied, in this embodiment of this specification, the facial recognition payment process can be simplified.

Trigger event 2: A tap input on a facial recognition payment button is detected, where the facial recognition payment button is located on the screen of the facial recognition device.

In an embodiment of this specification, a button for starting facial recognition payment can be displayed on the screen of the facial recognition device. If the user or a merchant taps the button on the screen, it can indicate that the facial recognition payment process currently needs to be started.

Trigger event 3: A key operation that is entered by using a physical keyboard and that corresponds to facial recognition payment is detected. In an embodiment of this specification, it can be set in advance that a key operation on the physical keyboard corresponds to starting of facial recognition payment. In this case, if the user or the merchant performs the key operation on the physical keyboard, it indicates that the facial recognition payment process currently needs to be started.

Trigger event 4: It is detected that an eye of a face gazes at the screen of the facial recognition device.

In an embodiment of this specification, when it is detected that the eye of the face gazes at the screen of the facial recognition device, it can also indicate that the user currently pays attention to the facial recognition device, and it can be proved that the user has an intention to start the facial recognition payment process. Therefore, based on the trigger event 3, it can indicate that the facial recognition payment process currently should be started, and confirmation of the payment intention of the user can also be advanced to the facial recognition payment start phase, thereby simplifying the facial recognition payment process.

Trigger event 5: It is detected that a human body movement corresponding to facial recognition payment appears on the screen of the facial recognition device.

In an embodiment of this specification, a human body movement corresponding to facial recognition payment can be agreed in advance, for example, the user makes a victory gesture or the user touches the face with a hand. The facial recognition payment process is started by using the human body movement agreed in advance. This processing method can increase fun experience of the user. In addition, because the processing method is based on a live human movement, difficulty of imitation is increased, and security of facial recognition payment is improved.

Trigger event 6: A voice password corresponding to facial recognition payment is detected.

In an embodiment of this specification, a voice password corresponding to facial recognition payment can be agreed in advance, for example, the user says “facial recognition payment”. This processing method can increase fun experience of the user.

Next, in step 103, the face image is obtained. A specific method for obtaining a human image can be the same as that in the existing technology. For example, a camera on the facial recognition device is started, so that the face image is captured.

It is worthwhile to note that, if the trigger event 1 or the trigger event 3 is used to trigger and start the facial recognition payment process in step 101, in step 103, a face image obtained in step 101 can also be directly used as the obtained face image.

In actual service implementations, a face of a non-transaction user may appear on the screen of the facial recognition device and cause interference. For example, a face of another person accidentally appears on the screen when the person passes through the facial recognition device. For another example, when a user who performs a transaction is accompanied by another person, a plurality of faces appear on the screen when the another person stands beside the user who performs a transaction. In this case, in an embodiment of the present specification, after step 103 of obtaining a face image, and before step 105 of performing identity verification on a user, any one of the following de-interference processing can be further performed: De-interference processing 1: Attention recognition is performed based on the face image obtained in step 103. If it is determined that attention of a corresponding face is on the screen of the facial recognition device, for example, an eye directly looks at the screen and/or a face directly faces the screen, it can indicate that a currently obtained face image is correct, that is, a user corresponding to the face image is exactly a user who currently needs to perform a transaction. In this case, step 105 of performing identity verification on a user based on the obtained face image can continue to be performed.

De-interference processing 2: It is determined, based on the face image obtained in step 103, whether at least two face images are currently obtained. If yes, spatial location data of a face corresponding to each face image relative to the screen of the facial recognition device are calculated, for example, a location or a distance of the face relative to the screen of the facial recognition device, for another example, a size of the face on the screen. Then, a probability corresponding to each face image is calculated by using the calculated spatial location data, a face image with a maximum probability value is determined as a face image of a user who currently needs to perform a transaction, and step 105 of performing identity verification on a user is performed based on the face image of the user who currently needs to perform a transaction. De-interference processing 3: After the face image is obtained in step 103, it is detected whether a human torso appears on the screen of the facial recognition device. If yes, it is determined whether the human torso and the obtained face image belong to a same user. If yes, it indicates that the user is indeed standing in front of the facial recognition device, and a face who currently needs to perform a transaction instead of an interfering face appears on the screen. In this case, processing in step 105 of performing identity verification on a user based on the obtained face image can continue to be performed.

Next, step 105 of performing identity verification on a user based on the obtained face image can specifically include the following: First, liveness detection is performed based on the obtained face image. Second, if the liveness detection succeeds, it indicates that the current face image is not a pre-prepared static image for imitation, but is a real face image collected on-site. Then, facial recognition is performed based on the obtained face image, it is determined whether a user identity corresponding to the face image can be recognized, and if yes, it indicates that the user identity is determined, for example, it is recognized that the face image corresponds to a user Zhang San with an identity number A. In this way, the identity verification on the user succeeds.

Next, in step 107 and step 109, after the identity verification on the user succeeds, the risk data of the user are obtained, it is determined, based on the risk data, whether the payment risk of the transaction is controllable, and if yes, it indicates that the user does not need to wait on-site for payment deduction to succeed. In this case, the user can be notified to leave.

In an embodiment of this specification, to evaluate a payment capability of the

user more comprehensively and more accurately determine whether the payment risk of the transaction is controllable, the risk data of the user can be obtained in a plurality of dimensions for determining. Specifically, in step 107, user risk data in N dimensions are obtained, where N is a positive integer. Preferably, N can be a natural number greater than 1. In addition, normalization processing is performed on user risk data in each dimension, to obtain a user risk vector in the dimension, where the user risk vector is a value in a range of 0 to 1. Correspondingly, in step 109, a specific implementation process of determining, by using the risk data, whether a payment risk of a transaction is controllable includes the following: calculating a user risk value by using the following equation 1:

$${R}^{u} ( {X}^{u} ) = {( {\prod }_{n = 1}^{N} {x}_{n}^{u} )}^{\frac{1}{a N}} , where 0 \leq {x}_{n}^{u} \leq 1 , constant a > 1$$

Here R^{u}(X^{u}) represents the user risk value, xₙ^{u} represents a user risk vector in an n^{th} dimension, a value of xₙ^{u} is a value in a range of 0 to 1, and n is any integer from 1 to N; determining whether the calculated user risk value is greater than a first predetermined value; and if yes, determining that the payment risk of the transaction is controllable.

The first predetermined value can be set to a value greater than or equal to 0 and less than 1 based on service needs.

In the above-mentioned equation 1, when N is a positive integer greater than 1, user risk vectors in a plurality of dimensions are used. Therefore, when a plurality of dimensions are considered, it is equivalent to that the risk is apportioned among the plurality of dimensions. In this case, the calculated user risk value should be less than a value of the user risk vector corresponding to each dimension. Therefore, the user risk vectors in the N dimensions are multiplied. This is equivalent to performing risk apportion processing, that is, risk reduction processing. After multiplication processing (that is, risk reduction processing) is performed, an obtained value is small, and the value obtained after multiplication can be further raised to the power of

$$\frac{1}{a N} .$$

This is equivalent to performing amplification processing on the value obtained after multiplication processing (that is, risk reduction processing), so that the payment risk of the transaction can be more clearly and differentially reflected by using a value obtained after amplification processing.

In the above-mentioned equation 1, the constant a is greater than 1, so that a result finally obtained by using the equation 1 can be amplified by a larger quantity of times, thereby further reflecting the payment risk of the transaction.

In an embodiment of this specification, the risk data of the user include any one of the following: historical behavior data of the user, consumption capability statistics data of the user, credit status data of the user, and a Zhima credit score of the user.

In actual service implementations, a transaction risk of facial recognition payment can come from any one of the user, the facial recognition device, and the merchant. For example, if the user has a poor history payment situation, the facial recognition device is attacked with a virus, and the merchant has a fraudulent transaction behavior, the transaction risk of facial recognition payment is not controllable. Therefore, whether the transaction risk is controllable can be determined respectively from the perspectives of the user, the facial recognition device, and the merchant.

In the above-mentioned embodiment of this specification, the implementation process of determining whether the payment risk of the transaction is controllable has been described from the perspective of the user. The following respectively describes, from the perspectives of the facial recognition device and the merchant, the implementation process of determining whether the payment risk of the transaction is controllable.

From the perspective of the facial recognition device: Before step 109 of notifying the user that the user can leave, the following steps are further performed: Step A1: Obtain risk data of the facial recognition device. Step B1: Determine, by using the risk data of the facial recognition device, whether the payment risk of the transaction is controllable; and if yes, continue to perform processing in step 109 of notifying the user that the user can leave.

In an embodiment of this specification, step A1 of obtaining risk data of the facial recognition device can include the following: obtaining risk data of the facial recognition device in M dimensions, where M is a positive integer; and performing normalization processing on risk data of the facial recognition device in each dimension, to obtain a risk vector of the facial recognition device in the dimension, where a value of the risk vector of the facial recognition device in each dimension is 0 or 1, that is, the risk vector is either 0 indicating that the risk is not controllable or 1 indicating that the risk is controllable, and there is no intermediate value between 0 and 1. In this case, step B1 of determining, by using the risk data of the facial recognition device, whether the payment risk of the transaction is controllable includes the following: calculating a device risk value by using the following equation 2:

$${R}^{d} ( {X}^{d} ) = {\prod }_{m = 1}^{M} {x}_{m}^{d} ,$$

Here R^{d} (X^{d}) represents the device risk value, xₘ^{d} represents a device risk vector in an m^{th} dimension, a value of xₘ^{d} is 0 or 1, and m is any integer from 1 to M; and

Determining whether the calculated device risk value is 1; and if the calculated device risk value is 1, determining that the payment risk of the transaction is controllable, and performing processing in step 109 of notifying the user that the user can leave; or if the calculated device risk value is not 1 but is 0, determining that the payment risk of the transaction is not controllable, and not notifying the user that the user can leave.

In the above-mentioned equation 2, the device risk vector xₘ^{d} has only two values: 0 or 1, and has no intermediate value. A reason is that regardless of which dimension where the facial recognition device generates a risk, the transaction cannot be performed. For example, if the value of the device risk vector in a dimension is 0, it may indicate that a software environment of the facial recognition device is attacked by a hacker. In this case, the transaction cannot be performed.

The risk data of the facial recognition device can include any one of the following: risk data of a software environment of the facial recognition device, risk data of a hardware environment of the facial recognition device, and communication network risk data.

In this case, the process of determining whether the payment risk of the transaction is controllable is completed from the perspective of the facial recognition device.

From the perspective of the merchant: Before step 109 of notifying the user that the user can leave, the following steps are further performed: Step A2: Obtain risk data of the merchant. Step B2: Determine, by using the risk data of the merchant, whether the payment risk of the transaction is controllable; and if yes, continue to perform processing in step 109 of notifying the user that the user can leave.

In an embodiment of this specification, step A2 of obtaining risk data of the merchant can include the following: obtaining merchant risk data in I dimensions, where I is a positive integer; and performing normalization processing on merchant risk data in each dimension, to obtain a merchant risk vector in the dimension, where the merchant risk vector in each dimension is a value in a range of 0 to 1. In this case, step B2 of determining, by using the risk data of the merchant, whether the payment risk of the transaction is controllable includes the following: calculating a merchant risk value by using the following equation 3:

$${R}^{m} ( {X}^{m} ) = {( {\prod }_{i = 1}^{I} {x}_{i}^{m} )}^{\frac{b}{I}} , where 0 \leq {x}_{i}^{m} \leq 1 , constant b > 1$$

Here R^{m}(X^{m}) represents the merchant risk value, xᵢ^{m} represents a merchant risk vector in an i^{th} dimension, xᵢ^{m} is a value in a range of 0 to 1, and i is any integer from 1 to I; determining whether the merchant risk value is greater than a second predetermined value; and if yes, determining that the payment risk of the transaction is controllable.

The second predetermined value can be set to a value greater than or equal to 0 and less than 1 based on service needs.

In the above-mentioned equation 3, when I is a positive integer greater than 1, merchant risk vectors in a plurality of dimensions are used. Therefore, when a plurality of dimensions are considered, it is equivalent to that the risk is apportioned among the plurality of dimensions. In this case, the calculated merchant risk value should be less than a risk value corresponding to each dimension. Therefore, the merchant risk vectors in the I dimensions are multiplied. This is equivalent to performing risk apportion processing, that is, risk reduction processing. After multiplication processing (that is, risk reduction processing) is performed, an obtained value is small, and the value obtained after multiplication can be further raised to the power of

$$\frac{b}{I} .$$

This is equivalent to properly performing amplification processing the value obtained after multiplication processing (that is, risk reduction processing), so that the payment risk of the transaction can be more clearly and differentially reflected by using a value obtained after amplification processing.

In the above-mentioned equation 3, the constant b is greater than 1, so that a result finally obtained by using the equation 3 can be amplified by a larger quantity of times, thereby further reflecting the payment risk of the transaction from the perspective of the merchant.

In an embodiment of this specification, the risk data of the merchant include any one of the following: historical behavior data of the merchant, credit status data of the user, and service level data of the merchant.

In the above-mentioned equation 1, to perform amplification processing, the value obtained after multiplication is raised to the power of

$$\frac{1}{a N} .$$

In the above-mentioned equation 3, to perform amplification processing, the value obtained after multiplication is raised to the power of

$$\frac{b}{I} .$$

When quantities of dimensions are equal, that is, when N=I, the amplification effect in the equation 1 is far greater than the amplification effect in the equation 3. A reason is that in actual service implementations, a determining result of a user payment risk is generally more important than a determining result of a merchant payment risk. A quantity of amplification times is increased, so that importance of the user payment risk can be more prominent.

Certainly, values of the quantities of dimensions in the above-mentioned three equations may not be equal, depending on actual service needs.

In addition, in an embodiment of this specification, whether the payment risk of the transaction is controllable can be determined from the perspectives of the user, the facial recognition device, and the merchant together. Specifically, the calculation results in the above-mentioned three equations are multiplied. If an obtained value is greater than a third predetermined value (the third predetermined value can be set to a value greater than or equal to 0 and less than 1 based on service needs), it can be considered that the payment risk of the transaction is controllable, and the user can be notified that the user can leave. Otherwise, it is considered that the payment risk of the transaction is not controllable, and the user is not notified that the user can leave.

In this case, in this embodiment of this specification, processing of determining whether the payment risk of the transaction is controllable is implemented.

After step 109, that is, after it is determined, by using the risk data, that the

payment risk of the transaction is controllable, processing of the acquiring and payment phase provided in this embodiment of this specification can be further performed, including the following: performing deduction processing by using obtained account information of the user, and if the deduction does not succeed, performing deduction from an account of a pre-established facial recognition payment fund pool. In this processing, because a platform that performs payment risk determining has determined that the payment risk of the transaction is controllable, if the subsequent deduction does not succeed, the platform can bear the loss, that is, performs deduction from the account of the pre-established facial recognition payment fund pool, so that the merchant successfully performs acquisition, missed payment is prevented, a money loss risk of unsuccessful deduction is transferred from the merchant to the platform, and the merchant does not need to take the risk of unsuccessful deduction. In addition, the merchant can enjoy a benefit of transferring the money loss risk without any subscription processing with the platform.

After step 109, that is, after it is determined, by using the risk data, that the payment risk of the transaction is not controllable, processing of the existing acquiring and payment phase can be further performed, including the following: performing deduction processing by using obtained account information of the user; and if the deduction does not succeed, notifying the user that the user cannot leave and the deduction fails; or if the deduction succeeds, notifying the user that the user can leave.

In conclusion, based on one or more facial recognition payment method embodiments provided in this specification, at least the following beneficial effects can be obtained: 1. After the identity verification on the user succeeds and it is determined that the payment risk of the transaction is controllable, when processing of the acquiring and payment phase is not performed, the user is notified that the user can leave. In this way, the user does not need to wait on-site during processing of the subsequent acquiring and payment phase, thereby reducing waiting time of the user.
2. In this embodiment of the specification, confirmation of the payment intention of the user can be advanced to the facial recognition payment start phase. In the entire facial recognition payment process, facial recognition needs to be performed on the user only once, instead of a total of two times of facial recognition in the existing technology, where facial recognition is performed once in the start phase, and facial recognition is performed once again in the acquiring and payment phase to confirm the payment intention. In this way, the facial recognition payment process is simplified.
3. De-interference processing can be performed on the obtained face image, thereby greatly reducing interference caused on the transaction when the face of the non-transaction user appears on the screen of the facial recognition device.
4. Whether the payment risk of the transaction is controllable can be determined from three perspectives: the user, the facial recognition device, and the merchant, so that the determining result is more accurate and comprehensive.
5. When the risk value is calculated from the perspective of the user or the merchant, risk apportion processing, that is, risk value reduction processing, can be performed first, and then risk value amplification processing is performed to prompt the risk. In this way, the calculated risk value can be more proper, and can represent a risk degree more easily.
6. After the platform has determined that the payment risk of the transaction is controllable, if the subsequent deduction does not succeed, the platform can bear the loss, that is, performs deduction from the account of the pre-established facial recognition payment fund pool, so that the merchant successfully performs acquisition, missed payment is prevented, a money loss risk of unsuccessful deduction is transferred from the merchant to the platform, and the merchant does not need to take the risk of unsuccessful deduction. In addition, the merchant can enjoy a benefit of transferring the money loss risk without any subscription processing with the platform.

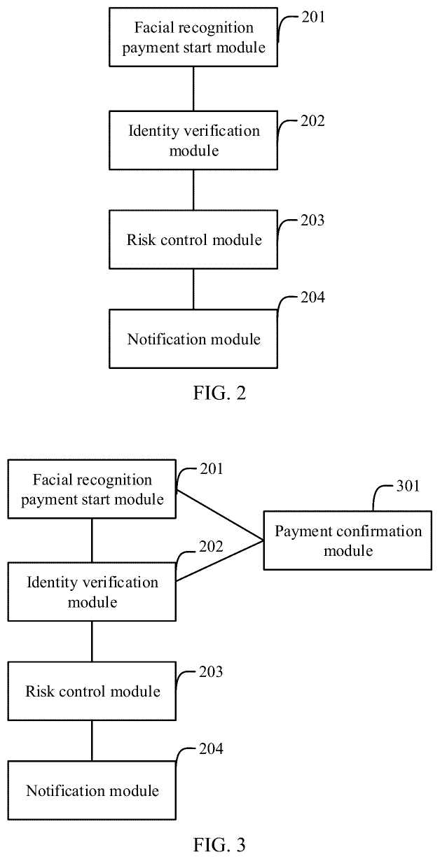

In an embodiment of this specification, a facial recognition payment apparatus is provided. Referring to FIG. 2, the apparatus includes the following: a facial recognition payment start module 201, configured to obtain a face image after a facial recognition payment trigger event is detected; an identity verification module 202, configured to perform identity verification on a user based on the obtained face image; a risk control module 203, configured to: after the identity verification on the user succeeds, obtain risk data of the user, and determine, by using the risk data of the user, whether a payment risk of a transaction is controllable; and a notification module 204, configured to: after the risk control module 203 determines that the payment risk of the transaction is controllable, notify the user that the user can leave.

In an embodiment of the apparatus provided in this specification, the facial recognition payment start module 201 is configured to: when any one of the following is detected, determine that the facial recognition payment trigger event is detected: detecting that a face appears on a screen of a facial recognition device; detecting a tap input on a facial recognition payment button, where the facial recognition payment button is located on the screen of the facial recognition device; detecting a key operation that is entered by using a physical keyboard and that corresponds to facial recognition payment; detecting that an eye of a face gazes at the screen of the facial recognition device; detecting that a human body movement corresponding to facial recognition payment appears on the screen of the facial recognition device; and detecting a voice password corresponding to facial recognition payment.

In an embodiment of the apparatus provided in this specification, referring to FIG. 3, the apparatus can further include a payment confirmation module 301, where the payment confirmation module 301 is configured to perform any one of the following processing: performing attention recognition based on the obtained face image, and if it is determined that attention is on the screen of the facial recognition device, triggering the identity verification module 202 to perform the step of performing identity verification on a user based on the obtained face image; determining whether at least two face images are currently obtained, if yes, calculating spatial location data of a face corresponding to each face image relative to the screen of the facial recognition device, calculating a probability corresponding to each face object by using the calculated spatial location data, determining a face image with a maximum probability value as a face image of the user, and triggering the identity verification module 202 to perform the step of performing identity verification on a user based on the obtained face image; and detecting whether a human torso appears on the screen of the facial recognition device, if yes, determining whether the human torso and the obtained face image belong to a same user, and if yes, triggering the identity verification module 202 to perform the step of performing identity verification on a user based on the obtained face image.

In an embodiment of the apparatus provided in this specification, the identity verification module 202 is configured to perform the following processing: performing liveness detection based on the obtained face image; and if the liveness detection succeeds, performing facial recognition based on the obtained face image, determining whether a user identity corresponding to the face image can be recognized, and if yes, enabling the identity verification on the user succeeds.

In an embodiment of the apparatus provided in this specification, the risk control module 203 is configured to perform the following processing: obtaining user risk data in N dimensions, where N is a positive integer; and performing normalization processing on user risk data in each dimension, to obtain a user risk vector in the dimension, where the user risk vector in each dimension is any value in a range of 0 to 1; and the determining, by using the risk data, whether a payment risk of a transaction is controllable includes the following: calculating a user risk value by using the following equation:

$${R}^{u} ( {X}^{u} ) = {( {\prod }_{n = 1}^{N} {x}_{n}^{u} )}^{\frac{1}{a N}} , where 0 \leq {x}_{n}^{u} \leq 1 , constant a > 1$$

Here R^{u}(X^{u}) represents the user risk value, xₙ^{u} represents a user risk vector in an n^{th} dimension, xₙ^{u} is a value in a range of 0 to 1, and n is any integer from 1 to N; determining whether the user risk value is greater than a first predetermined value; and if yes, determining that the payment risk of the transaction is controllable.

In an embodiment of the apparatus provided in this specification, the risk control module 203 is further configured to perform the following processing: obtaining risk data of a facial recognition device; and
determining, by using the risk data of the facial recognition device, whether the payment risk of the transaction is controllable.

In an embodiment of the apparatus provided in this specification, the risk control module 203 is configured to perform the following processing: obtaining risk data of the facial recognition device in M dimensions, where M is a positive integer; and performing normalization processing on risk data of the facial recognition device in each dimension, to obtain a risk vector of the facial recognition device in the dimension, where a value of the risk vector of the facial recognition device in each dimension is 0 or 1; and the determining, by using the risk data of the facial recognition device, whether the payment risk of the transaction is controllable includes the following: calculating a device risk value by using the following equation:

$${R}^{d} ( {X}^{d} ) = {\prod }_{m = 1}^{M} {x}_{m}^{d} ,$$

Here R^{d}(X^{d}) represents the device risk value, xₘ^{d} represents a device risk vector in an m^{th} dimension, a value of xₘ^{d} is 0 or 1, and m is any integer from 1 to M; determining whether the device risk value is 1; and if yes, determining that the payment risk of the transaction is controllable.

In an embodiment of the apparatus provided in this specification, the risk data of the facial recognition device include any one of the following: risk data of a software environment of the facial recognition device, risk data of a hardware environment of the facial recognition device, and communication network risk data.

In an embodiment of the apparatus provided in this specification, the risk control module 203 is further configured to perform the following processing: obtaining risk data of a merchant; determining, by using the risk data of the merchant, whether the payment risk of the transaction is controllable; and if yes, continuing to perform the step of notifying the user that the user can leave.

In an embodiment of the apparatus provided in this specification, the risk control module 203 is configured to perform the following processing: the obtaining risk data of a merchant includes: obtaining risk data of a merchant includes the following: obtaining merchant risk data in I dimensions, where I is a positive integer; and performing normalization processing on merchant risk data in each dimension, to obtain a merchant risk vector in the dimension, where a value of the merchant risk vector in each dimension is any value from 0 to 1; and the determining, by using the risk data of the merchant, whether the payment risk of the transaction is controllable includes the following: calculating a merchant risk value by using the following equation:

$${R}^{m} ( {X}^{m} ) = {( {\prod }_{i = 1}^{I} {x}_{i}^{m} )}^{\frac{b}{I}} , where 0 \leq {x}_{i}^{m} \leq 1 , constant b > 1$$

Here R^{m}(X^{m}) represents the merchant risk value, xᵢ^{m} represents a device risk vector in an i^{th} dimension, a value of xᵢ^{m} is any value from 0 to 1, and i is any integer from 1 to I; determining whether the merchant risk value is greater than a second predetermined value; and if yes, determining that the payment risk of the transaction is controllable.

In an embodiment of the apparatus provided in this specification, the risk data of the merchant include any one of the following: historical behavior data of the merchant, credit status data of the user, and service level data of the merchant.

In an embodiment of the apparatus provided in this specification, the risk data of the user include any one of the following: historical behavior data of the user, consumption capability statistics data of the user, credit status data of the user, and a Zhima credit score of the user.

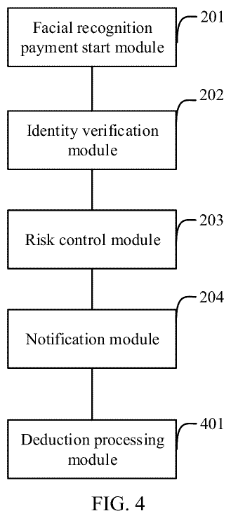

In an embodiment of the apparatus provided in this specification, referring to FIG. 4, the apparatus further includes a deduction processing module 401, where the deduction processing module 401 is configured to perform at least one of the following processing: after the risk control module 203 determines that the payment risk of the transaction is controllable, performing deduction processing by using obtained account information of the user, and if the deduction does not succeed, performing deduction from an account of a pre-established facial recognition payment fund pool; after the risk control module 203 determines that the payment risk of the transaction is not controllable, performing deduction processing by using obtained account information of the user; and if the deduction does not succeed, notifying the user that the deduction fails; or if the deduction succeeds, notifying the user that the user can leave.

In an embodiment of this specification, the facial recognition payment apparatus can be integrated into a facial recognition device, or can be integrated into an independent device connected to the facial recognition device.

Based on an embodiment of another aspect, a computer-readable storage medium that stores a computer program is further provided. When the computer program is executed on a computer, the computer is enabled to perform the method described in any one of the embodiments of this specification.

Based on an embodiment of still another aspect, a computing device is further provided, including a memory and a processor. The memory stores executable code, and when executing the executable code, the processor implements the method the method described in any one of the embodiments of this specification.

The embodiments in this specification are described in a progressive way. For same or similar parts of the embodiments, references can be made to the embodiments mutually. Each embodiment focuses on a difference from other embodiments. Particularly, apparatus embodiments are substantially similar to method embodiments, and therefore are described briefly. For related parts, references can be made to related descriptions in the method embodiments.

A person skilled in the art should be aware that in the above-mentioned one or more examples, functions described in this application can be implemented by hardware, software, firmware, or any combination thereof. When this application is implemented by software, the functions can be stored in a computer-readable medium or transmitted as one or more instructions or code in the computer-readable medium.

The objectives, technical solutions, and beneficial effects of this application are further described in detail in the above-mentioned specific implementations. It should be understood that the above-mentioned descriptions are merely specific implementations of this application, but are not intended to limit the protection scope of this application. Any modification, equivalent replacement, or improvement made based on the technical solutions of this application shall fall within the protection scope of this application.

What is claimed is:

1. A facial recognition payment method, comprising:
detecting a facial recognition payment trigger event;
obtaining a face image;
performing identity verification on a user based on the obtained face image;
after the identity verification on the user succeeds, obtaining risk data of the user;
determining, by using the risk data of the user, whether a payment risk of a transaction is controllable; and
if yes, notifying the user that the user can leave.

2. The method according to claim 1, wherein the detecting a facial recognition payment trigger event comprises any one of the following:
detecting that a face appears on a screen of a facial recognition device;
detecting a tap input on a facial recognition payment button, wherein the facial recognition payment button is located on the screen of the facial recognition device;
detecting a key operation that is entered by using a physical keyboard and that corresponds to facial recognition payment;
detecting that an eye of a face gazes at the screen of the facial recognition device;
detecting that a human body movement corresponding to facial recognition payment appears on the screen of the facial recognition device; and
detecting a voice password corresponding to facial recognition payment.

3. The method according to claim 1, wherein after the obtaining a face image, and before the performing identity verification on a user based on the obtained face image, any one of the following processing further is performed:
performing attention recognition based on the obtained face image, and if it is determined that attention is on a screen of the facial recognition device, continuing to perform the step of performing identity verification on the user based on the obtained face image;
if at least two face images are currently obtained, calculating spatial location data of a face corresponding to each face image relative to the screen of the facial recognition device, calculating a probability corresponding to each face image by using the calculated spatial location data, determining a face image with a maximum probability value as a face image of the user, and performing identity verification on the user based on the face image of the user; and
if it is detected that a human torso appears on the screen of the facial recognition device, determining whether the human torso and the obtained face image belong to a same user, and if yes, continuing to perform the step of performing identity verification on a user based on the obtained face image.

4. The method according to claim 1, wherein the performing identity verification on a user based on the obtained face image comprises:
performing liveness detection based on the obtained face image; and
if the liveness detection succeeds, performing facial recognition based on the obtained face image, determining whether a user identity corresponding to the face image can be recognized, and if yes, enabling the identity verification on the user succeeds.

5. The method according to claim 1, wherein
the obtaining risk data of the user comprises:
obtaining user risk data in N dimensions, wherein N is a positive integer; and
performing normalization processing on user risk data in each dimension, to obtain a user risk vector in the dimension; and
the determining, by using the risk data, whether a payment risk of a transaction is controllable comprises:
calculating a user risk value by using the following equation:
$${R}^{u} ( {X}^{u} ) = {( {\prod }_{n = 1}^{N} {x}_{n}^{u} )}^{\frac{1}{a N}} , where 0 \leq {x}_{n}^{u} \leq 1 , constant a > 1$$
wherein R^{u}(X^{u}) represents the user risk value, xₙ^{u} represents a user risk vector in an n^{th} dimension, and n is any integer from 1 to N; and
if the user risk value is greater than a first predetermined value, determining that the payment risk of the transaction is controllable.

6. The method according to claim 1, wherein before the notifying the user that the user can leave, the method further comprises:
obtaining risk data of a facial recognition device; and
determining, by using the risk data of the facial recognition device, whether the payment risk of the transaction is controllable.

7. The method according to claim 6, wherein
the obtaining risk data of a facial recognition device comprises:
obtaining risk data of the facial recognition device in M dimensions, wherein M is a positive integer; and
performing normalization processing on risk data of the facial recognition device in each dimension, to obtain a risk vector of the facial recognition device in the dimension; and
the determining, by using the risk data of the facial recognition device, whether the payment risk of the transaction is controllable comprises:
calculating a device risk value by using the following equation:
$${R}^{d} ( {X}^{d} ) = {\prod }_{m = 1}^{M} {x}_{m}^{d} ,$$
wherein R^{d}(X^{d}) represents the device risk value, xₘ^{d} represents a device risk vector in an m^{th} dimension, a value of xₘ^{d} is 0 or 1, and m is any integer from 1 to M; and
if the device risk value is 1, determining that the payment risk of the transaction is controllable.

8. The method according to claim 6, wherein the risk data of the facial recognition device comprise any one of the following: risk data of a software environment of the facial recognition device, risk data of a hardware environment of the facial recognition device, and communication network risk data.

9. The method according to claim 1, wherein before the notifying the user that the user can leave, the method further comprises:
obtaining risk data of a merchant; and
determining, by using the risk data of the merchant, whether the payment risk of the transaction is controllable.

10. The method according to claim 9, wherein
the obtaining risk data of a merchant comprises:
obtaining merchant risk data in I dimensions, wherein I is a positive integer; and
performing normalization processing on merchant risk data in each dimension, to obtain a merchant risk vector in the dimension; and
the determining, by using the risk data of the merchant, whether the payment risk of the transaction is controllable comprises:
calculating a merchant risk value by using the following equation:
$${R}^{m} ( {X}^{m} ) = {( {\prod }_{i = 1}^{I} {x}_{i}^{m} )}^{\frac{b}{I}} , where 0 \leq {x}_{i}^{m} \leq 1 , constant b > 1$$
wherein R^{m}(X^{m}) represents the merchant risk value, xᵢ^{m} represents a merchant risk vector in an i^{th} dimension, and i is any integer from 1 to I; and
if the merchant risk value is greater than a second predetermined value, determining that the payment risk of the transaction is controllable.

11. The method according to claim 9, wherein the risk data of the merchant comprise any one of the following: historical behavior data of the merchant, credit status data of the user, and service level data of the merchant.

12. The method according to claim 1, wherein the risk data of the user comprise any one of the following: historical behavior data of the user, consumption capability statistics data of the user, credit status data of the user, and a Zhima credit score of the user.

13. The method according to claim 1, wherein
after it is determined, by using the risk data, that the payment risk of the transaction is controllable, the method further comprises: performing deduction processing by using account information of the user, and if the deduction does not succeed, performing deduction from an account of a pre-established facial recognition payment fund pool; and/or
after it is determined, by using the risk data, that the payment risk of the transaction is not controllable, the method further comprises: performing deduction processing by using account information of the user; and if the deduction does not succeed, notifying the user that the deduction fails; or if the deduction succeeds, notifying the user that the user can leave.

14-25. (canceled)

26. A non-transitory computer-readable storage medium having stored therein instructions that, in response to execution by a processor of a device, cause the device to:
detect a facial recognition payment trigger event;
obtain a face image;
perform identity verification on a user based on the obtained face image;
after the identity verification on the user succeeds, obtain risk data of the user;
determine, by using the risk data of the user, whether a payment risk of a transaction is controllable; and
if yes, notify the user that the user can leave.

27. A computing device, comprising a memory and a processor, wherein the memory stores executable instructions that, in response to execution by the processor, cause the computing device to:
detect a facial recognition payment trigger event
obtain a face image;
perform identity verification on a user based on the obtained face image;
after the identity verification on the user succeeds, obtain risk data of the user;
determine, by using the risk data of the user, whether a payment risk of a transaction is controllable; and
if yes, notify the user that the user can leave.
